(19) United States
(12) Patent Application Publication
(10) Pub. No.: US 2013/0010981 A1
(43) Pub. Date: Jan. 10, 2013

(54) MICROPHONE

(75) Inventors: Hiroyuki Harano, Kurate-gun (JP); Hiroshi Yamagata, Kurate-gun (JP); Kazuo Ono, Kurate-gun (JP); Kensuke Nakanishi, Kurate-gun (JP)

(73) Assignee: HOSIDEN CORPORATION, Osaka (JP)

(21) Appl. No.: 13/583,474

(22) PCT Filed: Mar. 10, 2011
(86) PCT No.: PCT/JP2011/055644

§ 371 Date: Sep. 7, 2012

(30) Foreign Application Priority Data
Apr. 6, 2010 (JP) 2010-087479

(51) Int. Cl. H04B 15/00

(52) U.S. Cl. 381/94.1

(57) ABSTRACT

A microphone capable of canceling vibration noise caused by mechanical vibration is provided with, in capsules, a pair of diaphragms and a pair of back plates opposite to the respective diaphragms. A printed circuit board is disposed at the middle of capsules. A pair of diaphragms is disposed close and opposite to the surfaces of the printed circuit board with the printed circuit board disposed therebetween. The difference in distance from a vibration source to the two diaphragms is made small. The microphone has a high canceling effect for canceling vibration noise caused by mechanical vibration.

### TECHNICAL FIELD

The present invention relates to a microphone structured to be capable of canceling vibration noise caused by mechanical vibration.

### BACKGROUND ART

FIG. 1 shows a structure described in Patent literature 1 as a conventional example of this type of microphone.

In this example, two electret condenser microphone units are disposed in a holder 1. In FIG. 1, the microphone units have diaphragms 2a and 2b, and opposite electrodes (back plates) 3a and 3b are respectively disposed opposite to the diaphragms 2a and 2b. The opposite electrodes 3a and 3b are connected to the gate terminal of a field effect transistor (FET) 4.

The opposite electrodes 3a and 3b and the FET 4 are supported by a supporting member 5, and the opposite electrodes 3a and 3b are disposed opposite each other with the FET 4 placed therebetween. The diaphragms 2a and 2b are positioned at the outer sides of the opposite electrodes 3a and 3b, respectively.

The holder 1 has a through hole 6 and also has a narrow gap 7e between the supporting member 5 and the inner wall of the holder 1. Ring-shaped members 8a and 8b provided at the outer sides of the diaphragms 2a and 2b in order to form outer cavities 7a and 7b are cut to form paths 7c and 7d, respectively.

Sound waves input from the through hole 6 pass through the narrow gap 7e, the paths 7c and 7d, and the outer cavities 7a and 7b to reach the diaphragms 2a and 2b. Independent inner cavities 9a and 9b, not connecting with each other, are formed between the opposite electrodes 3a and 3b.

With this structure, in-phase output signals can be obtained from the two microphone units for the input sound waves, whereas opposite-phase outputs can be obtained for vibration noise caused by mechanical vibration, allowing the vibration noise to be canceled.

### PRIOR ART LITERATURE

### Patent Literature

[Patent literature 1] Japanese Patent Application Laid-Open No. 02-41099 (Japanese Registered Patent No. 2748417)

### SUMMARY OF THE INVENTION

### Problems to be Solved by the Invention

In the microphone structured as described above, the two diaphragms 2a and 2b are disposed at both ends of the microphone; in other words, the two diaphragms 2a and 2b are disposed far apart. Therefore, when the vibration source is located beside a side wall (the left or right) of the holder 1, for example, the difference ΔL₁ in distance from the vibration source to the two diaphragms 2a and 2b is large, which is a disadvantage in canceling the vibration noise caused by the mechanical vibration.

Accordingly, an object of the present invention is to provide a microphone having a high vibration-noise canceling effect by making the distance between two diaphragms very small.

### Means to Solve the Problems

According to the present invention, a microphone capable of canceling vibration noise caused by mechanical vibration includes a pair of diaphragms and a pair of back plates opposite the respective diaphragms in a capsule; a printed circuit board is disposed at the middle of the capsule; and the pair of diaphragms are disposed close and opposite to the surfaces of the printed circuit board, respectively, with the printed circuit board disposed therebetween.

### Effects of the Invention

According to the present invention, the distance between the two diaphragms is made very small, which makes the difference in distance from the vibration source to the two diaphragms small. Therefore, a high canceling effect is obtained with respect to vibration noise caused by mechanical vibration.

### BRIEF DESCRIPTION OF THE DRAWINGS

FIG. 1 is a cross sectional view showing the structure of a conventional microphone;

FIG. 2A is a perspective view of the appearance of a microphone according to an embodiment of the present invention, seen from an upper side, and FIG. 2B is a perspective view of the microphone shown in FIG. 2A, seen from a lower side;

FIG. 3 is a cross sectional view of the microphone shown in FIGS. 2A and 2B;

FIG. 4 is an exploded perspective view of the microphone shown in FIGS. 2A and 2B;

FIG. 5A is a view showing pattern details on a printed circuit board, seen from an upper side, and FIG. 5B is a view showing pattern details on the printed circuit board, seen from a lower side;

FIG. 6A is a perspective view showing the printed circuit board with a component mounted thereon, seen from an upper side, and FIG. 6B is a perspective view showing the printed circuit board with components mounted thereon, seen from a lower side;

FIG. 7A is a perspective view of the microphone shown in FIGS. 2A and 2B with a holder mounted thereon, seen from an upper side, FIG. 7B is a perspective view of the microphone shown in FIGS. 2A and 2B with the holder mounted thereon, seen from a lower side, and FIG. 7C is a cross sectional view of the microphone shown in FIGS. 2A and 2B with the holder mounted thereon;

FIG. 8 is a cross sectional view of a microphone according to another embodiment of the present invention; and

FIG. 9 is a cross sectional view of a microphone according to a modification of the present invention.

### DETAILED DESCRIPTION OF THE EMBODIMENTS

Embodiments of the present invention will be described below.

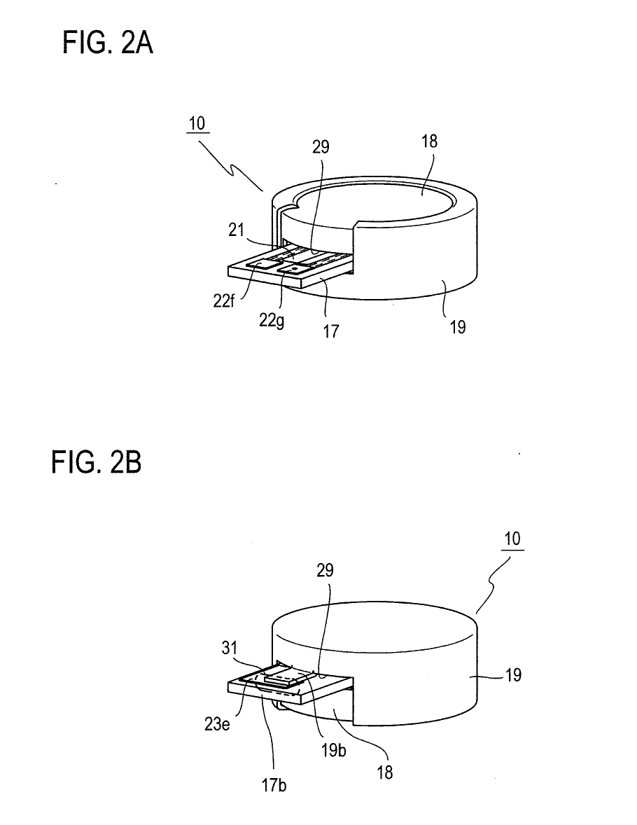

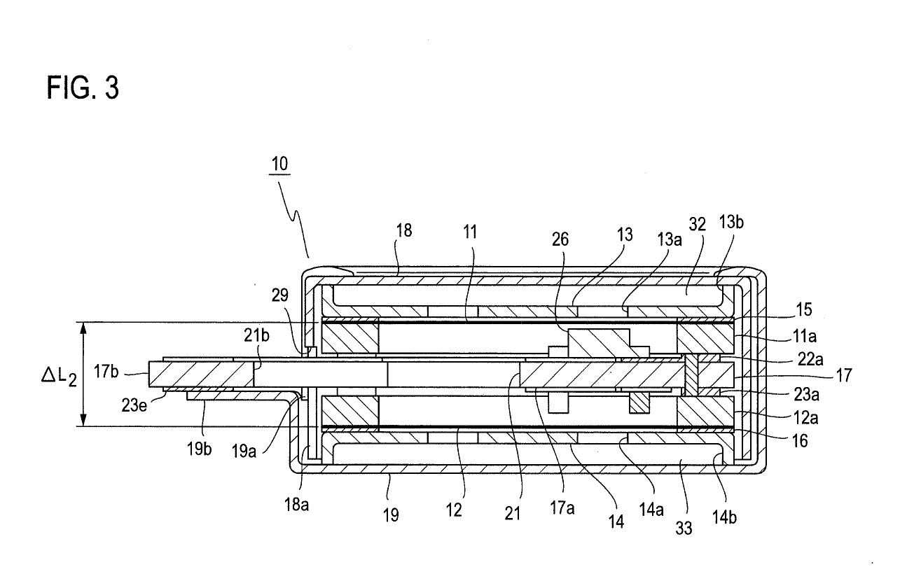

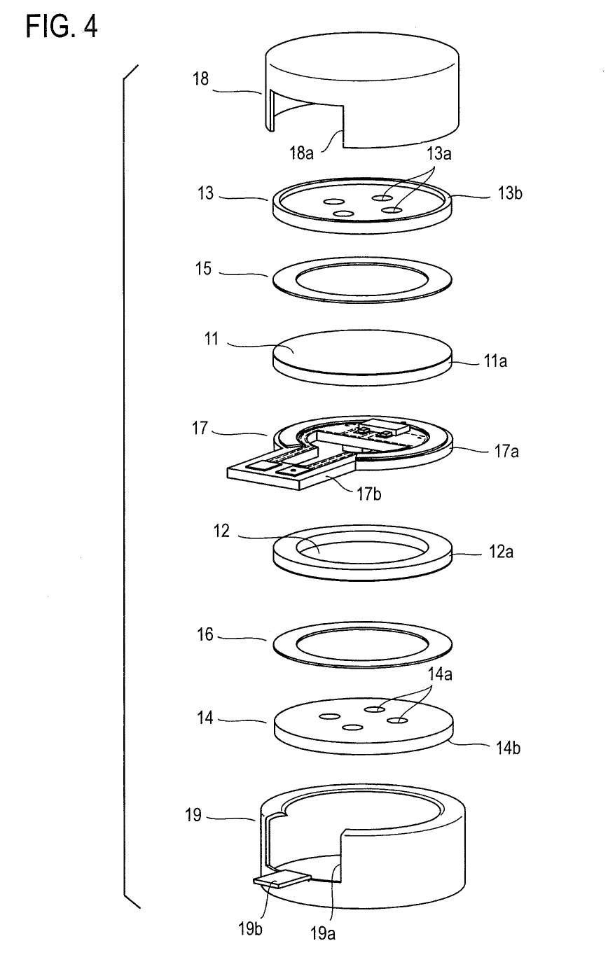

FIGS. 2A and 2B show the appearance of a microphone according to an embodiment of the present invention. FIG. 3 shows the cross sectional structure thereof. FIG. 4 shows an exploded view thereof. In this embodiment, a microphone 10 is formed of a pair of diaphragms 11 and 12 glued to and supported by rings 11a and 12a, a pair of back plates 13 and 14, a pair of spacers 15 and 16, a printed circuit board 17 on which predetermined patterns are formed and components are mounted, and a capsule for accommodating the above.

In this embodiment, the capsule is divided into two upper and lower capsules 18 and 19, and these capsules 18 and 19 are cylinders with one end face closed, as shown in FIG. 4.

The capsule 18 is cut from an open end face at a cylindrical wall to form an opening 18a. In the same way, the capsule 19 is cut from an open end face at a cylindrical wall to form an opening 19a. A protruding piece 19b is bent from the capsule 19 at an inner end (close to the closed end face) of the opening 19a so as to protrude toward the outside.

The capsule 18 is slightly smaller in diameter than the capsule 19, so that the capsule 18 can be put inside the capsule 19. FIG. 4 shows a state in which the open end face of the capsule 19 is crimped in assembly, which will be described later.

The pair of back plates 13 and 14 are circular and have four through holes 13a and 14a on their plate faces, respectively. In this embodiment, the back plates 13 and 14 have peripheral walls 13b and 14b having a predetermined height at their circumferences, respectively. The back plates 13 and 14 having the peripheral walls 13b and 14b can be formed, for example, by drawing. Electrets are formed on the faces of the back plates 13 and 14, which oppose the diaphragms 11 and 12, but they are not shown in the drawings.

The spacers 15 and 16 are made from an insulating material and are ring shaped in the same way as the rings 11a and 12a, which support the diaphragms 11 and 12.

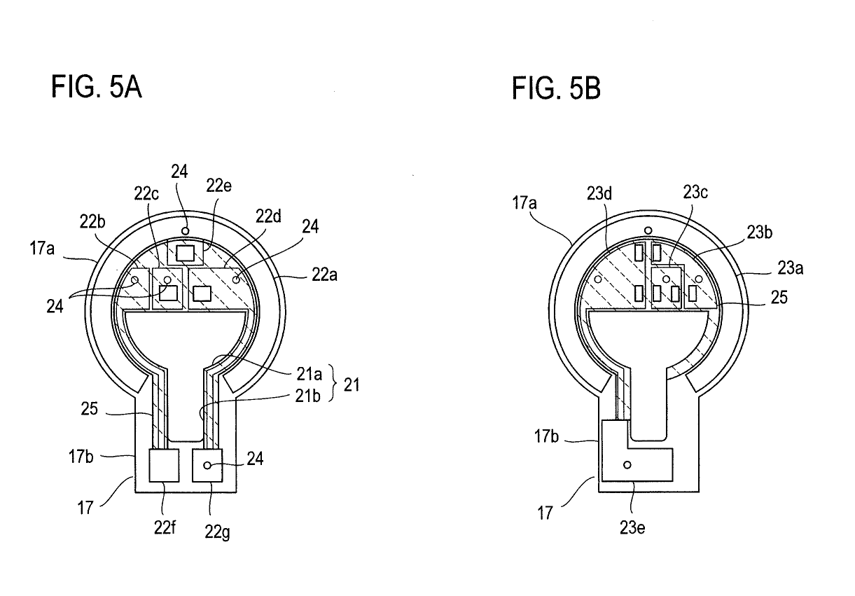

The printed circuit board 17 is formed of a circular part 17a and a rectangular protruding part 17b protruding from a part of the circumference of the circular part 17a. FIGS. 5A and 5B show details of the printed circuit board 17. The printed circuit board 17 has a large opening 21 from the protruding part 17b to the center of the circular part 17a. The opening 21 has a semi-circular part 21a concentric with the circular part 17a in the circular part 17a, and an extending part 21b extending from the semi-circular part 21a to the protruding part 17b.

As shown in FIG. 5A, an arc-shaped pattern 22a concentric with the circular part 17a and three island-shaped patterns 22b, 22c, and 22d are formed on the upper surface of the circular part 17a of the printed circuit board 17. A pattern 22e is formed at the center of the circumference of the arc-shaped pattern 22a in a protruding manner toward the center of the circular part 17a. Terminals 22f and 22g connected to the patterns 22b and 22d, respectively, are formed on the upper surface of the protruding part 17b.

As shown in FIG. 5B, an arc-shaped pattern 23a and three island-shaped patterns 23b, 23c, and 23d are formed on the lower surface of the circular part 17a in the same manner as on the upper surface. A pattern 23e connected to the pattern 23d is formed on the lower surface of the protruding part 17b. The patterns 22a and 23a, the patterns 22b and 23b, the patterns 22c and 23c, the patterns 22d and 23d, and the terminal 22g and the pattern 23e are electrically connected to each other via through holes 24. In FIGS. 5A and 5B, hatched portions with broken lines indicate areas coated with resist 25.

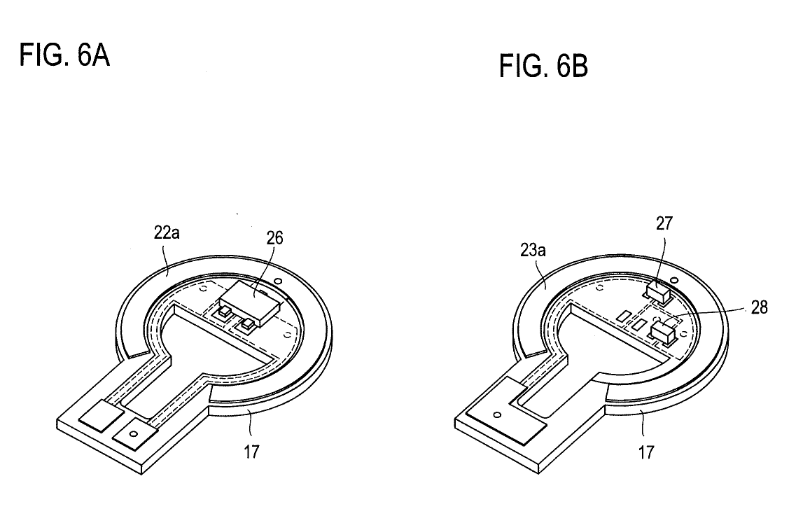

FIGS. 6A and 6B show the printed circuit board 17 structured in the foregoing manner with components mounted thereon. An FET 26 is mounted on the upper surface of the printed circuit board 17, as shown in FIG. 6A, and a capacitor 27 and a resistor 28 are mounted on the lower surface of the printed circuit board 17, as shown in FIG. 6B.

The assembly of the microphone 10 will be described next.

The back plate 13, the spacer 15, the ring 11a supporting the diaphragm 11, the printed circuit board 17 with the components mounted thereon, the ring 12a supporting the diaphragm 12, the spacer 16, and the back plate 14 are sequentially put into the capsule 18 in stacked manner, then the capsule 18 is covered with the capsule 19, and the open end of the capsule 19 is crimped to assemble the microphone 10.

When assembling the microphone 10, the openings 18a and 19a of the capsules 18 and 19 are positioned at the same location, and the protruding part 17b of the printed circuit board 17 protrudes toward the outside of the capsules 18 and 19 from an opening 29 formed when the openings 18a and 19a are positioned. The protruding piece 19b of the capsule 19 is disposed so as to face and contact the lower surface of the protruding part 17b of the printed circuit board 17, and the protruding piece 19b is connected to the pattern 23e formed on the protruding part 17b by soldering to complete the microphone 10, as shown in FIGS. 2A, 2B, and 3. In FIG. 2B, a two-dot chain line shows an area where solder 31 is applied.

The pair of diaphragms 11 and 12 face the back plates 13 and 14 with the spacers 15 and 16 placed therebetween, respectively, and the pair of diaphragms 11 and 12 are disposed so as to be close and opposite to the surfaces of the printed circuit board 17 with the printed circuit board 17 placed therebetween.

The rings 11a and 12a respectively supporting the diaphragms 11 and 12 face and contact the patterns 22a and 23a of the printed circuit board 17, respectively, so that the pair of diaphragms 11 and 12 are connected to the gate terminal of the FET 26.

The extending part 21b of the opening 21 of the printed circuit board 17 is partially exposed to the outside. In this embodiment, sound waves are input to the capsules 18 and 19 through the opening 21 of the printed circuit board 17 and are transmitted to the diaphragms 11 and 12.

Since the diaphragms 11 and 12 are disposed very close to the printed circuit board 17 and the printed circuit board 17 serves as a sound inlet in the way described above, the back plates 13 and 14 serve as back chambers that support the stiffness of the diaphragms 11 and 12. In this embodiment, the peripheral walls 13b and 14b are provided for the back plates 13 and 14, respectively, by drawing, and spaces surrounded by the peripheral walls 13b and 14b are covered with the closed end faces of the capsules 18 and 19 to form back chambers 32 and 33. With this structure, the back chambers 32 and 33 can be easily formed without using any other members.

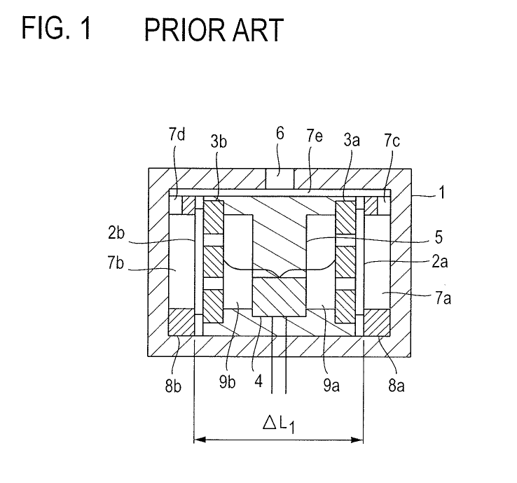

According to the microphone 10 structured as described above, the pair of diaphragms 11 and 12 are provided to allow in-phase output signals to be generated for input sound waves and opposite-phase outputs to be generated for vibration noise caused by mechanical vibration, so that the vibration noise can be canceled. Since the pair of diaphragms 11 and 12 are disposed so as to be close to and face each other with the printed circuit board 17 placed therebetween, the difference ΔL₂ in distance from the vibration source to the two diaphragms 11 and 12 is made much smaller in this embodiment compared with that for the conventional microphone shown in FIG. 1. Therefore, the microphone 10 has a higher vibration-noise canceling effect than the conventional microphone.

In this embodiment, since sound waves are input to the microphone 10 from the opening 21 of the printed circuit board 17, the sound waves can be guided to the upper and lower vibration systems (the pair of diaphragms 11 and 12) uniformly. In addition, in this embodiment, since the rings 11a and 12a respectively supporting the diaphragms 11 and 12 directly face and contact the patterns 22a and 23a of the printed circuit board 17, respectively, in other words, since the rings 11a and 12a for the diaphragms 11 and 12 also serve as the gate ring of the FET 26, the structure is made simpler, the stray capacitance around the gate of the FET 26 is reduced, and a high output is possible.

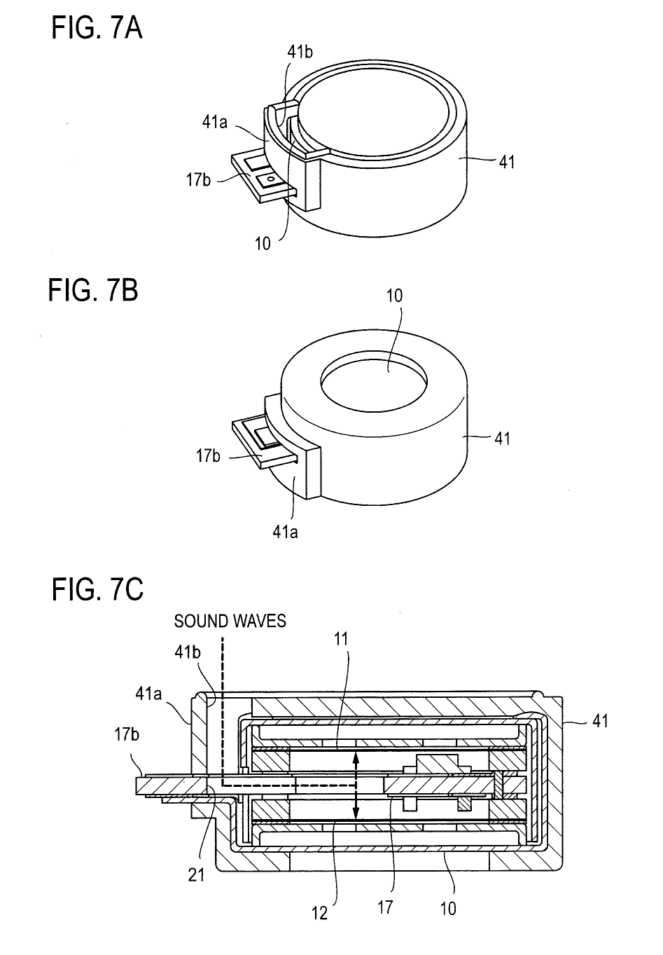

When the microphone 10 is mounted in an electronic device, the terminals 22f and 22g formed on the protruding part 17b of the printed circuit board 17 are connected to terminals on a printed circuit board of the electronic device with lead wires. Usually, the microphone 10 is placed in a rubber holder before being mounted. FIGS. 7A, 7B, and 7C show the microphone 10 to which a holder 41 is attached.

The holder 41 has a protruding part 41a corresponding to the protruding part 17b of the printed circuit board 17. The protruding part 41a has an opening 41b connected to the opening 21 of the printed circuit board 17.

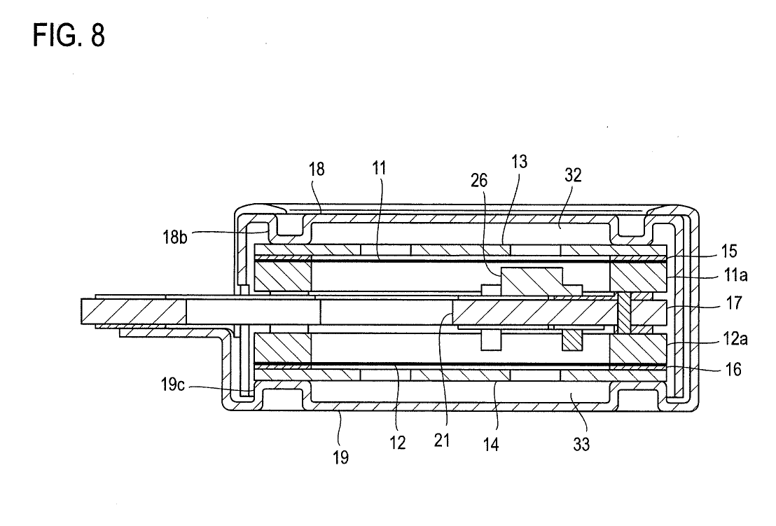

FIG. 8 shows a microphone according to another embodiment of the present invention. Unlike in the foregoing embodiment, in which the back plates 13 and 14 are provided with the peripheral walls 13b and 14b to form the back chambers 32 and 33, in this embodiment, the closed end faces of the capsules 18 and 19 are made to have gutters, as shown in FIG. 8; in other words, projections 18b and 19c protruding inward are foamed in the circumference at peripheral portions of the closed end faces of the capsules 18 and 19, respectively, to make back chambers 32 and 33. The back plates 13 and 14 are simple circular plates. Spaces surrounded by the projections 18b and 19c are covered with the back plates 13 and 14 to form the back chambers 32 and 33. Such a structure can be employed.

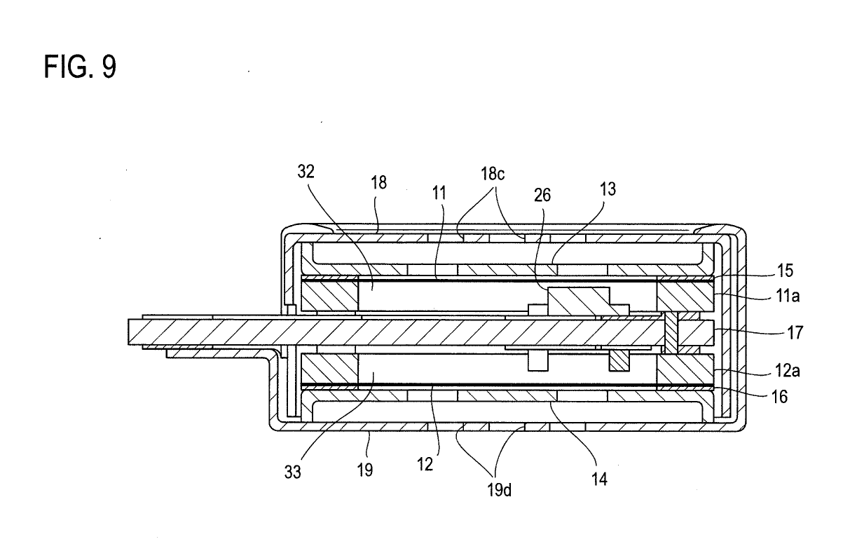

In the above-described embodiments, sound waves are input to the microphone from the opening 21 of the printed circuit board 17; in other words, sound waves are input from a side of the microphone. Instead of that structure, another structure may be used in which sound holes 18c and 19d are formed in the closed end faces of the capsules 18 and 19, as shown in FIG. 9, so that sound waves are input from the upper and lower directions of the microphone. In that case, the printed circuit board 17 does not have the opening 21, and the back chambers 32 and 33 are formed between the printed circuit board 17 and the diaphragms 11 and 12.

### INDUSTRIAL APPLICABILITY

A microphone according to the present invention is effective when used as a vibration canceling microphone for canceling zooming sounds in a digital video camera (DVC) or a digital still camera (DSC), and can be applied, for example, to a device that requires countermeasures for vibration such as noise caused by touch.

1. A microphone capable of canceling vibration noise caused by mechanical vibration, comprising in a capsule:
a pair of diaphragms; and
a pair of back plates opposite to the respective diaphragms;
a printed circuit board being disposed at the middle of the capsule; and
the pair of diaphragms being disposed close and opposite to the surfaces of the printed circuit board, respectively, with the printed circuit board disposed therebetween.

2. The microphone according to claim 1,
wherein the printed circuit board has a protruding part protruding toward the outside of the capsule, and the printed circuit board has an opening a part of which is located at the protruding part; and
sound waves are input to the capsule through the opening.

3. The microphone according to claim 2,
wherein the printed circuit board has a circular part accommodated in the capsule and the protruding part, which protrudes from a part of the circumference of the circular part, and
the opening extends to the center of the circular part.

4. The microphone according to claim 2,
wherein the protruding part protrudes toward the outside of the capsule from an opening of the capsule, and
a protruding piece is formed at the opening of the capsule to face and contact the protruding part.

5. The microphone according to claim 2, wherein an external-connection terminal is formed at the protruding part.

6. The microphone according to claim 1,
wherein the pair of diaphragms are respectively glued to and supported by rings; and
the rings face and contact the printed circuit board.

7. The microphone according to claim 1, wherein the back plates have peripheral walls and spaces surrounded by the peripheral walls are covered by end faces of the capsule to form back chambers.

8. The microphone according to claim 1, wherein projections protruding inward are formed in a circumference at peripheral portions of end faces of the capsule, and spaces surrounded by the protruding projections are covered by the back plates to form back chambers.

9. The microphone according to claim 2,
wherein the pair of diaphragms are respectively glued to and supported by rings; and
the rings face and contact the printed circuit board.

10. The microphone according to claim 2, wherein the back plates have peripheral walls and spaces surrounded by the peripheral walls are covered by end faces of the capsule to form back chambers.

11. The microphone according to claim 2, wherein projections protruding inward are formed in a circumference at peripheral portions of end faces of the capsule, and spaces surrounded by the protruding projections are covered by the back plates to form back chambers.

12. The microphone according to claim 3,
wherein the pair of diaphragms are respectively glued to and supported by rings; and
the rings face and contact the printed circuit board.

13. The microphone according to claim 3, wherein the back plates have peripheral walls and spaces surrounded by the peripheral walls are covered by end faces of the capsule to form back chambers.

14. The microphone according to claim 3, wherein projections protruding inward are formed in a circumference at peripheral portions of end faces of the capsule, and spaces surrounded by the protruding projections are covered by the back plates to form back chambers.

15. The microphone according to claim 4,
wherein the pair of diaphragms are respectively glued to and supported by rings; and
the rings face and contact the printed circuit board.

16. The microphone according to claim 4, wherein the back plates have peripheral walls and spaces surrounded by the peripheral walls are covered by end faces of the capsule to form back chambers.

17. The microphone according to claim 4, wherein projections protruding inward are formed in a circumference at peripheral portions of end faces of the capsule, and spaces surrounded by the protruding projections are covered by the back plates to form back chambers.

18. The microphone according to claim 5,
wherein the pair of diaphragms are respectively glued to and supported by rings; and
the rings face and contact the printed circuit board.

19. The microphone according to claim 5, wherein the back plates have peripheral walls and spaces surrounded by the peripheral walls are covered by end faces of the capsule to form back chambers.

20. The microphone according to claim 5, wherein projections protruding inward are formed in a circumference at peripheral portions of end faces of the capsule, and spaces surrounded by the protruding projections are covered by the back plates to form back chambers.
